(19) United States
(12) Patent Application Publication
(10) Pub. No.: US 2002/0004377 A1
(43) Pub. Date: Jan. 10, 2002

(54) Device and method for improved filtering in a radio receiver in the microwave range

(76) Inventors: Goran Snygg, Partille (SE); Erik Carlsson, Molndal (SE)

Correspondence Address: NIXON & VANDERHYE P.C., 8th Floor, 1100 North Glebe Road, Arlington, VA, 22201, US

(21) Appl. No.: 09/866,867

(22) Filed: May 30, 2001

(30) Foreign Application Priority Data
May 30, 2000 (SE) 0002008-1

(51) Int. Cl. H04B 1/16

(52) U.S. Cl. 455/339; 455/126

(57) ABSTRACT

The invention relates to a system (500) for radio communication in the microwave range, comprising a transmitting device and a receiving device, said transmitting device comprising a transmitter (530), an antenna (510′), a filter (520′) with variable filter characteristics, and a device (550′) for controlling the variable filter (520′), and said receiving device comprising a receiver (540), an antenna (510), a filter (520) with variable filter characteristics, and a device (550) for controlling the variable filter (520). The filters (520, 520′) are arranged between the antenna and the transmitter, and the antenna and the receiver, respectively, the filters have variable filter characteristics, and said devices (550, 550′) for controlling the respective filters are responsive to control signals from an external source, whereby the frequency range at which the respective device and thereby the whole system (500) operates can be controlled during operation.

### TECHNICAL FIELD

This invention relates to a device and a method for achieving, by means of improved filtering, an improved signal to noise ratio in a radio receiver, particularly in the microwave range. The invention can also be used to achieve increased flexibility in a system for communication in the microwave range.

### CURRENT TECHNOLOGY

Interference signals can often be a problem in wireless telecommunication systems, as they have an adverse effect on the signal to noise ratio. The interference signals can be intentional or unintentional, and can originate, for example, from adjacent systems operating at the same frequency range. In line with the development of mobile telephony and other types of wireless communication in the microwave range, the likelihood of receiving interference signals in systems operating at these frequencies will increase, which in turn increases the need to be able effectively to provide protection against or to eliminate interference signals received.

Conventional transmitting devices for reception in wireless telecommunication in the microwave range usually comprise an antenna connected to a receiver, with receiving devices comprising a bandpass filter between the receiver and the antenna. The function of the bandpass filter is to filter out signals that lie outside the frequency range at which the device in question can operate, which means that transmitted or received interference signals that lie within the frequency range at which the device operates cannot be eliminated by the bandpass filter. Received interference signals can therefore degrade the signal to noise ratio.

In the receiver the received signal is usually converted down to lower frequencies, and, in order to be able to improve the signal to noise ratio in a signal that has been affected by interference signals, to date there have been various types of signal processing of the signal that comes out of the receiver, in other words the converted signal.

As the signal processing is carried out on the signal that comes out of the receiver, there is a limit to how much the signal to noise ratio can be improved by the signal processing, due to the fact that the interference signal has already passed through the receiver and thus can be present in the converted signal.

In other words, there is a need to be able to improve the signal to noise ratio in a device operating in the microwave range, in a better way than was previously available.

### DESCRIPTION OF THE INVENTION

The problem that is solved by the current invention is a better way than was previously available of being able to improve the signal to noise ratio in a system for radio communication in the microwave range.

The problem is solved by providing a system for radio communication in the microwave range, comprising a transmitting device and a receiving device, the transmitting device comprising a transmitter, an antenna, a filter with variable filter characteristics, and a device for controlling the variable filter. The receiving device comprises a receiver, an antenna, a filter with variable filter characteristics, and a device for controlling the variable filter.

The filters are arranged between the antenna and the transmitter, and the antenna and the receiver, respectively, and have variable filter characteristics, with each of the devices for controlling the respective filters being responsive to control signals from an external source, whereby the frequency range at which the respective device and thereby the whole system operates can be controlled during operation. This enables the system to adaptively, during operation, change its frequency range in response to undesired signals which interfer with the communications of the system.

Suitably, the external source for control signals for the device for controlling the variable filter in the transmitting device is the device for controlling the variable filter in the receiving device and vice versa, whereby the two control devices are in communication with each other, enabling the system to change frequency range rapidly and easily in response to jamming or interference.

The variable filter is suitably either a bandpass or a notch filter, which means that it can be used to eliminates interference signals without significantly impairing the received useful signal.

### DESCRIPTION OF THE FIGURES

In the following, the invention will be described in greater detail utilizing examples of preferred embodiments and with reference to the attached figures, in which:

FIG. 1 shows a principle underlying the invention, and

FIG. 2 shows a communication system and a source of interference, and

FIG. 3 shows a device according to the invention, and

FIG. 4 shows filter characteristics for two different filters that can be incorporated in a device according to the invention, and

FIG. 5 shows a system according to a variant of the invention, and

FIG. 6 shows filter characteristics for filters from FIG. 5.

### EMBODIMENTS

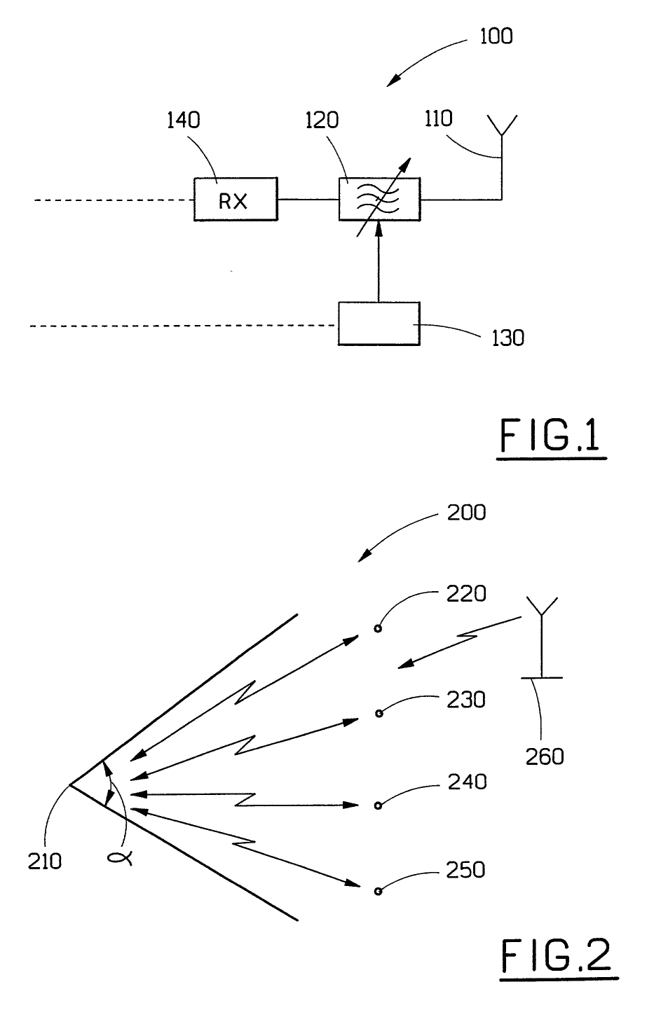

FIG. 1 shows a principle underlying the invention: In a device 100 in the microwave range an antenna 110 is used to receive electromagnetic signals. The device comprises in addition a receiver 140, and variable filter 120 which is connected between the antenna and the receiver. In order to be able to control the variable filter, the device comprises in addition a means 130 for controlling the variable filter.

The fact that the variable filter 120 is arranged so that the signal received by the antenna 110 passes through the filter before it reaches the receiver 140 means that the filter can be used to adapt the signal that reaches the receiver. The means 130 for controlling the variable filter can be arranged in a number of different ways, which will be described later, as will the filter 120.

FIG. 2 shows schematically a communication system 200 in which the invention can be used, a so-called point-to-multipoint system. A central radio station 210 is used to communicate with a number of other radio stations 220, 230, 240, 250 within a certain sector. The central radio station covers the whole sector with its antenna, an area with an angle α, normally approximately 90 degrees, while the antenna of each of the stations with which it communicates only covers a fairly narrow sector.

In addition to the stations that are part of the system, there is also another radio station 260 in the vicinity that transmits at the same frequency range as the system 200 within the sector that is covered by the system, which means that these transmissions are received by the central radio station 210. In traditional systems there are two different possible ways of solving the problem of the received interference signals. The first of these is to change the frequencies at which the units 210-250 in the system communicate, which is an expensive measure that may possibly not be permissible if the operator does not have a licence to transit on other frequencies. The other measure that has been able to be used to date is to signal process the signal that comes out of the receiver in the respective units 210-250 and that thus is already combined with the interference signal.

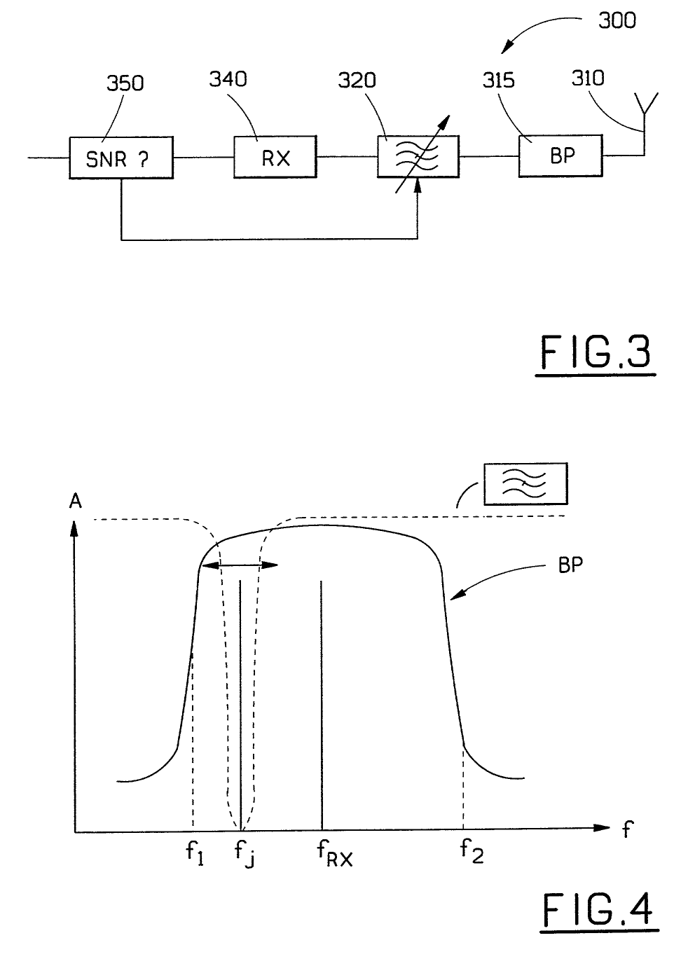

FIG. 3 shows a device 300 according to the invention which solves the problem of received interference signals in a better way than the previously known method. The device 300 comprises a receiver 340, an antenna 310, a filter 320 with variable filter characteristics and a means 350 for controlling the variable filter. The variable filter 320 is arranged between the antenna 310 and the receiver 340, which means that it can be used to reduce or completely eliminate interference signals before these have even reached the receiver, which provides improved opportunities for obtaining a good signal to noise ratio. The device 300 comprises in addition a bandpass filter 315, the function of which is to suppress or eliminate signals outside the frequency range at which the device operates. The bandpass filter 315 is suitably arranged between the receiver 340 and the antenna 310.

The variable filter 320 is suitably a notch filter, in other words a filter with a very narrow suppressed frequency band. This filter characteristic and the fact that the filter 320 is variable means that the suppressed frequency band can be controlled so that it eliminates interference signals that arise practically anywhere within the frequency range at which the device 300 operates. For this purpose, the device also comprises a means 350 for controlling the variable filter 320 so that its suppressed frequency band is optimal with regard to the received interference signal.

In order that the control of the filter 320 is carried out in the best way, the means 350 for controlling the filter can, for example, comprise a device that measures the signal to noise ratio (SNR) in the signal after the receiver 340. If the SNR after the receiver drops below a certain predetermined level, the filter's suppressed frequency band is controlled so that it sweeps across the whole operating range of the receiver. The values of SNR for different positions on the suppressed frequency band are compared, for example by being stored in a table, and the position of the middle frequency of the suppressed frequency band that gives the best SNR is used. If no interference signal is present, the notch filter can be controlled so that its suppressed frequency band is as far from the useful signal as possible.

FIG. 4 shows schematically the filter characteristics of two filters that are found in the device 300 in FIG. 3, the bandpass filter (BP) and the variable notch filter. The bandpass filter is used to remove interference signals outside an operating range, f₁ f₂, for the device. The figure shows a received useful signal f_{RX} and a received interference signal fⱼ. As the interference signal lies within the operating range, the bandpass filter will not be able to suppress it. The notch filter, with its narrow suppressed frequency band, has been controlled so that the suppressed frequency band is centred around the interference frequency fⱼ, which means that the effect of the interference frequency is reduced considerably, whereby the desired effect of the invention is achieved, namely that the signal that reaches the receiver is “clean”.

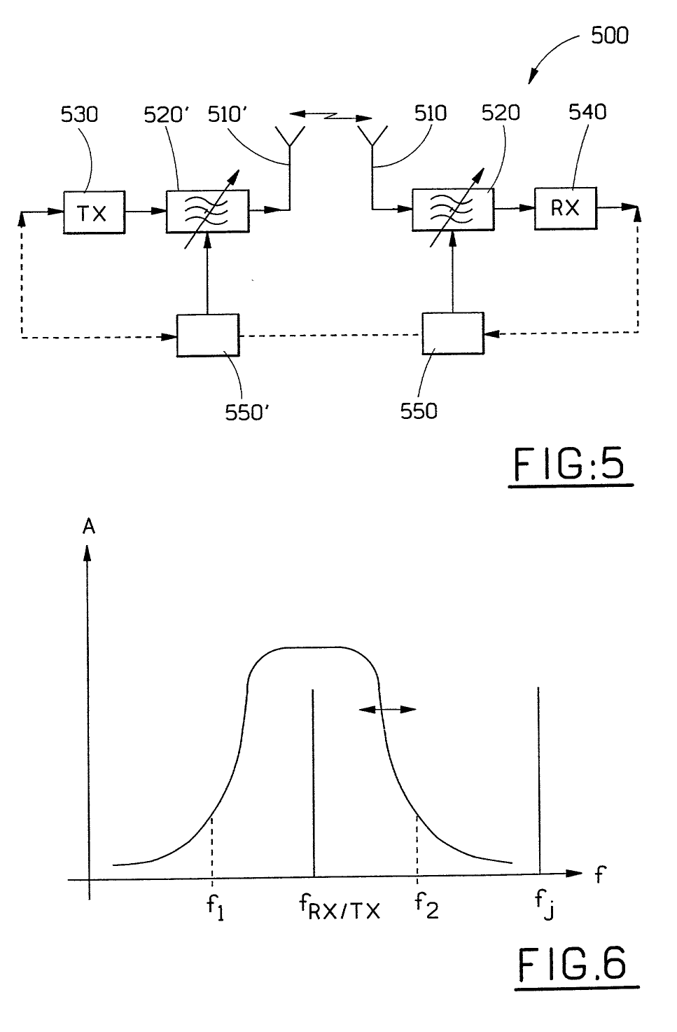

FIG. 5 shows a variant of the invention, in a system 500 for radio communication in the microwave range. The system 500 comprises a transmitting device and a receiving device, where the transmitting device comprises a transmitter 530, an antenna 510′, a filter 520′ with variable filter characteristics, and a device 550′ for controlling the variable filter 520′, and the receiving device comprises a receiver 540, an antenna 510, a filter 520 with variable filter characteristics, and a device 550 for controlling the variable filter 520.

In a similar way to that described above, the variable filters 520, 520′ are arranged between the antennas 510, 510′ and the receiver 540 and transmitter 530 respectively, which means that the variable filters can be controlled in such a way that the frequency range at which the respective device and thereby the whole system 500 operates can be controlled during operation.

Unlike the device that has been described above, in this variant of the invention the variable filter 520, 520′ in the respective device can be a notch filter, but is preferably a bandpass filter, whose function is to suppress spurious signals in the transmitting device with its passband, and to “cut out” only the frequency range that it is wished to receive in the receiving device. This is shown schematically in FIG. 6, where a pass band that extends between the frequencies f₁ and f₂ is shown, and can be moved to avoid the affect of an interference signal fⱼ. The passband has been centred around the transmitting link's frequency f_{TX}, which consequently corresponds to the receiving link's frequency f_{RX}.

In order to change the transmission/reception frequency, it has been necessary in previous devices either to change the filters in the transmitting/receiving device, or to change the whole device. With a variable filter according to the invention, the frequencies can be changed on site, or by remote control, whereby a number of advantages are obtained:

Changes to frequency planning are made considerably easier, as the changes can be carried out on site, without replacing hardware.

The frequency at which the device is to operate can be determined on site, which means that an operator can purchase and stock a “standard device”, instead of a great many different devices for different frequencies.

If it is noticed that the system is receiving (or transmitting) interference frequencies, the transmission/reception frequency can easily be changed.

The transmitting and receiving devices must, of course, both change frequency in the event of a frequency change, which means that they need to be “coordinated”. When changing frequency planning, this can be carried out by the means 550, 550′ in each device for controlling its variable filter being responsive to control signals from an external source, such as, for example, a received from a central control device, and in this way being commanded to change the middle frequency of its pass band. Alternatively, one device can signal to the other, suitably via a separate signal channel, that it wants to change frequency, and the frequency change is then implemented.

If the frequency change is carried out in order to eliminate the transmission or reception of interference signals, it can also be possible to have a method where the devices test a number of transmission/reception frequencies in order to find out which provides the best result.

The receiving and/or transmitting devices in the system 500 can, of course, be supplemented in such a way that they also comprise a variable notch filter connected between the antennas 510, 510′ and the transmitter 520 or receiver 530 respectively.

1. A system (500) for radio communication in the microwave range, comprising a transmitting device and a receiving device, said transmitting device comprising a transmitter (530), an antenna (510′), a filter (520′) with variable filter characteristics, and a device (550′) for controlling the variable filter (520′), and said receiving device comprising a receiver (540), an antenna (510), a filter (520) with variable filter characteristics, and a device (550) for controlling the variable filter (520), the system being characterized in that
the filters (520, 520′) are arranged between the antenna and the transmitter, and the antenna and the receiver, respectively,
the filters have variable filter characteristics,
each of said devices (550, 550′) for controlling the respective filters are responsive to control signals from an external source,
whereby the frequency range at which the respective device and thereby the whole system (500) operates can be controlled during operation.

2. A system (500) according to claim 1, in which the external source for control signals for the device for controlling the variable filter (520′) in the transmitting device is the device (550) for controlling the variable filter (520) in the receiving device and vice versa, whereby the two control devices are in communication with each other.

3. A system (500) according to claim 1, in which the external source for control signals for the device for controlling the variable filter (520′, 520) in the transmitting device and in the receiving device is a central control device.

4. A system according to any of claims 1-3, in which the variable filters (520′, 520) in the transmitting device and in the receiving device are bandpass filters.

5. A system according to any of claims 1-3, in which the variable filters (520′, 520) in the transmitting device and in the receiving device are notch filters.

6. A method for use in a system (500) for radio communication in the microwave range, the system having a transmitting device and a receiving device, said transmitting device comprising a transmitter (530), an antenna (510′), a filter (520′) with variable filter characteristics, and a device (550′) for controlling the variable filter (520′), and said receiving device comprising a receiver (540), an antenna (510), a filter (520) with variable filter characteristics, and a device (550) for controlling the variable filter (520), the method being characterized in that
arranging the filters (520, 520′) between the antenna and the transmitter, and the antenna and the receiver, respectively,
providing the filters with variable filter characteristics,
making each of said devices (550, 550′) for controlling the respective filters responsive to control signals from an external source,
whereby the frequency range at which the respective device and thereby the whole system (500) operates can be controlled during operation.

7. A method according to claim 6, in which the external source whose control signals the device for controlling the variable filter (520′) in the transmitting device is responsive to is the device (550) for controlling the variable filter (520) in the receiving device and vice versa, whereby the two control devices are in communication with each other.

8. A method (500) according to claim 6, in which the external source whose control signals the device for controlling the variable filter (520′, 520) in the transmitting device and in the receiving device are responsive to is a central control device.
